(19) United States
(12) Patent Application Publication
(10) Pub. No.: US 2025/0298219 A1
(43) Pub. Date: Sep. 25, 2025

(54) OPTICAL IMAGING SYSTEM

(71) Applicant: Samsung Electro-Mechanics Co., Ltd., Suwon-si (KR)

(72) Inventors: Ju Hwa SON, Suwon-si (KR); Yong Joo JO, Suwon-si (KR); Phil Ho JUNG, Suwon-si (KR)

(73) Assignee: Samsung Electro-Mechanics Co., Ltd., Suwon-si (KR)

(21) Appl. No.: 19/016,143

(22) Filed: Jan. 10, 2025

(30) Foreign Application Priority Data
Mar. 22, 2024 (KR) 10-2024-0039671

(51) Int. Cl. G02B 13/00; G02B 9/64

(52) U.S. Cl. CPC G02B 13/0045; G02B 9/64

(57) ABSTRACT

An optical imaging system is provided. The optical imaging system includes a first lens, a second lens, a third lens, a fourth lens having positive refractive power, a fifth lens, a sixth lens, a seventh lens having positive refractive power, an eighth lens and a ninth lens, wherein the first lens to the ninth lens are disposed in order from an object side, and wherein conditional expressions 1.0<F-number<1.4 and 1.30≤TTL/f<1.40 are satisfied, where TTL is a distance from an object-side surface of the first lens to an image plane on an optical axis, and f is a focal length of the optical imaging system.

### CROSS-REFERENCE TO RELATED APPLICATIONS

This application claims the benefit under 35 USC § 119 (a) of Korean Patent Application No. 10-2024-0039671 filed on Mar. 22, 2024, in the Korean Intellectual Property Office, the entire disclosure of which is incorporated herein by reference for all purposes.

### BACKGROUND

### 1. Field

The following descriptive relates to an optical imaging system.

### 2. Description of Related Art

An optical system which may output bright images has been implemented in mobile devices. The brightness of an image may be related to an F value of the optical system, and the smaller the F value, the brighter the image may be represented. To lower an F value, a size of an entrance pupil may be increased, but as an entrance pupil increases, aberrations may occur.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, an optical imaging system includes a first lens, a second lens, a third lens, a fourth lens having positive refractive power, a fifth lens, a sixth lens, a seventh lens having positive refractive power, an eighth lens, and a ninth lens, wherein the first lens to the ninth lens are disposed in order from an object side, and wherein conditional expressions 1.0<F-number<1.4 and 1.30≤TTL/f<1.40 are satisfied, where TTL is a distance from an object-side surface of the first lens to an image plane on an optical axis, and f is a focal length of the optical imaging system.

Both an image-side surface of the third lens and an object-side surface of the fourth lens may be concave.

The fifth lens may have a concave object-side surface.

The sixth lens may have a concave image-side surface.

The seventh lens and the eighth lens may include an inflection point on at least one of an object-side surface and an image-side surface.

The eighth lens may have a convex image-side surface.

The first lens to the ninth lens may include three or more lenses which have a refractive index equal to or greater than 1.60.

A conditional expression 0.70≤TTL/(2*IMG HT)<0.80, may be satisfied, where IMG HT is a half of diagonal length of the image plane.

In a general aspect, an optical imaging system includes a first lens, a second lens, a third lens, a fourth lens, a fifth lens, a sixth lens, a seventh lens, an eighth lens, and a ninth lens disposed in order from an object side, wherein the seventh lens has positive refractive power, and wherein the eighth lens has a convex image-side surface.

The second lens, the third lens and the sixth lens may have a refractive index equal to or greater than 1.60.

The seventh lens and the eighth lens may include an inflection point on at least one of an object-side surface and an image-side surface.

The fourth lens and the fifth lens may have positive refractive power.

A conditional expression 1.0<F-number<1.4 may be satisfied.

The sixth lens may have negative refractive power and a concave image-side surface.

The third lens may have positive refractive power.

The sixth lens may have a convex object-side surface.

A conditional expression 1.30≤TTL/f<1.40 may be satisfied, where TTL is a distance from an object-side surface of the first lens to an image plane on the optical axis, and f is a focal length of the optical imaging system.

A conditional expression 0.70≤TTL/(2*IMG HT)<0.80 may be satisfied, where TTL is a distance from an object-side surface of the first lens to an image plane on an optical axis, and 2*IMG HT is a diagonal length of the image plane.

Other features and aspects will be apparent from the following detailed description, the drawings, and the claims.

### BRIEF DESCRIPTION OF DRAWINGS

FIG. 1 is a configuration diagram illustrating an example optical imaging system in accordance with a first embodiment.

FIG. 2 is a graph illustrating aberration properties of the example optical imaging system in accordance with the first embodiment.

FIG. 3 is a configuration diagram illustrating an example optical imaging system in accordance with a second embodiment.

FIG. 4 is a graph illustrating aberration properties of the example optical imaging system in accordance with the second embodiment.

FIG. 5 is a configuration diagram illustrating an example optical imaging system in accordance with a third embodiment.

FIG. 6 is a graph illustrating aberration properties of the example optical imaging system in accordance with the third embodiment.

FIG. 7 is a configuration diagram illustrating an example optical imaging system in accordance with a fourth embodiment.

FIG. 8 is a graph indicating aberration properties of the example optical imaging system in accordance with the fourth embodiment.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

One or more examples may provide an optical imaging system which has a low F value and a slim thickness.

In the one or more embodiments, a unit of values of radius of curvature, thickness, distance, focal length, IMG HT (½ of a diagonal length of an image plane), and semi-aperture of a lens may be in millimeters (mm), and a unit of a field of view (FOV) may be in degree) (°). Additionally, a thickness of a lens and a distance between lenses may refer to a thickness and a distance on an optical axis.

In the one or more embodiments, an object side may indicate the direction in which the object is disposed, and an image side may indicate the direction in which an image plane on which the image is formed, that is, the image sensor, is disposed.

In the description related to the shape of a lens of the embodiments, a convex surface may indicate that a paraxial region (a narrow region in vicinity of an optical axis) portion of a surface may be convex, and a concave surface may indicate that a paraxial region portion of the surface may be concave. Accordingly, even when one surface of the lens is described as having a convex shape, an edge portion of the lens may be concave. Similarly, although one surface of a lens is described as having a concave shape, an edge portion of the lens may be convex.

The optical imaging system according to the one or more embodiments may be implemented in a camera of a mobile device. The mobile device may be any type of portable electronic device including, but not limited to, a smartphone.

According to the one or more embodiments, the optical imaging system may include nine lenses. For example, the optical imaging system may include a first lens, a second lens, a third lens, a fourth lens, a fifth lens, a sixth lens, a seventh lens, an eighth lens, and a ninth lens disposed in order from an object side. The first lens to the ninth lens may each be disposed at a distance from adjacent lenses.

According to the one or more embodiments, the optical imaging system may include a plastic lens. For example, at least a portion of the first lens to the ninth lens may be configured as a plastic material, and preferably, the first lens to the ninth lens may be configured as plastic materials.

According to the one or more embodiments, the optical imaging system may include an aspherical lens. For example, at least one of object-side surfaces and image-side surfaces of the first lens to the ninth lens may be aspherical, and preferably, both object-side surfaces and image-side surfaces of the first lens to the ninth lens may be aspherical. The aspherical surface of the lens may be represented by equation 1 below.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} + {LY}^{22} + {MY}^{24} + {NY}^{26} + {OY}^{28} + {PY}^{30} \qquad Equation 1$$

In equation 1, c is the reciprocal of a radius of curvature of the lens, K is the conic constant, Y is the distance from any point on the aspherical surface to an optical axis, A-H, J, and L-P are aspherical constants from the 4th to the 30th order in order, and Z (or SAG) is the distance from any point on the aspherical surface to an apex of the aspherical surface in the optical axis direction.

According to the one or more embodiments, the optical imaging system may further include an infrared cut-off filter, an image sensor, and a stop. In the one or more embodiments, the infrared cut-off filter may be disposed between the ninth lens and the image sensor to block infrared light of light incident to the image sensor through the ninth lens. Additionally, in the one or more embodiments, the stop may be disposed between the third lens and the fourth lens, and may adjust the amount of light incident to the lens.

According to the one or more embodiments, the optical imaging system may satisfy one or more of the conditional expressions as indicated below:

$$( 1 ) \qquad 1.0 < F \text{-} number < 1.4$$

$$( 2 ) \qquad 1.30 \leq TTL / f < 1.40$$

$$( 3 ) \qquad 0.70 \leq TTL / ( 2 * IMG HT ) < 0.80$$

In the conditional expressions, TTL is the distance on the optical axis from an object-side surface of the first lens to an image plane, f is a focal length of the optical imaging system, and 2*IMG HT is a diagonal length of the image plane.

Conditional expression (1) may be related to brightness properties of the optical imaging system according to the one or more embodiments. The optical imaging system according to the one or more embodiments may be implemented as a bright optical system in accordance with conditional expression (1).

Conditional expressions (2) and (3) may be related to the miniaturization and slimming of the optical imaging system according to the one or more embodiments. Particularly, the optical imaging system according to the one or more embodiments may have a low F value and may implement miniaturization and slimming, the difficulty of which may be relatively high.

The optical imaging system according to the one or more embodiments may further satisfy at least one of conditional expressions (2) and (3) while satisfying conditional expression (1).

Additionally, the optical imaging system according to the one or more embodiments may satisfy one or more of the conditional expressions as indicated below.

$$( 4 ) \qquad 1.0 < f 1 / f < 1.5$$

$$( 5 ) \qquad - 5 < f 2 / f < - 2$$

$$( 6 ) \qquad 20 < \vert f 3 / f \vert$$

$$( 7 ) \qquad 1 < f 4 / f < 5$$

$$( 8 ) \qquad 6 < f 5 / f < 12$$

$$( 9 ) \qquad - 5 < f 6 / f < - 2$$

$$( 10 ) \qquad 6 < f 7 / f$$

$$( 11 ) \qquad 0 < f 8 / f < 1.5$$

$$( 12 ) \qquad - 2 < f 9 / f < 0$$

$$( 13 ) \qquad BFL / f < 0.18$$

$$( 14 ) \qquad 0.1 < F \text{-} number / IMG HT < 0.5$$

$$( 15 ) \qquad 2 < T 1 / T 9 < 4$$

$$( 16 ) \qquad 1.7 < TTL / Σ CT < 1.9$$

$$( 17 ) \qquad 2.8 < TTL / Σ AT < 3.2$$

In the conditional expressions, f1 is a focal length of the first lens, f2 is a focal length of the second lens, f3 is a focal length of the third lens, f4 is a focal length of the fourth lens, f5 is a focal length of the fifth lens, f6 is a focal length of the sixth lens, f7 is a focal length of the seventh lens, f8 is a focal length of the eighth lens, and f9 is a focal length of the ninth lens. Additionally, BFL is the distance from an image-side surface of the ninth lens to the image plane on the optical axis, T1 is a thickness of the first lens on the optical axis, T9 is a thickness of the ninth lens on the optical axis, ΣCT is the sum of the thicknesses of the first lens to the ninth lens on the optical axis, and ΣAT is the sum of the distances of the first lens to the ninth lens on the optical axis.

Hereinafter, the optical imaging system according to the one or more embodiments may be described.

### First Embodiment

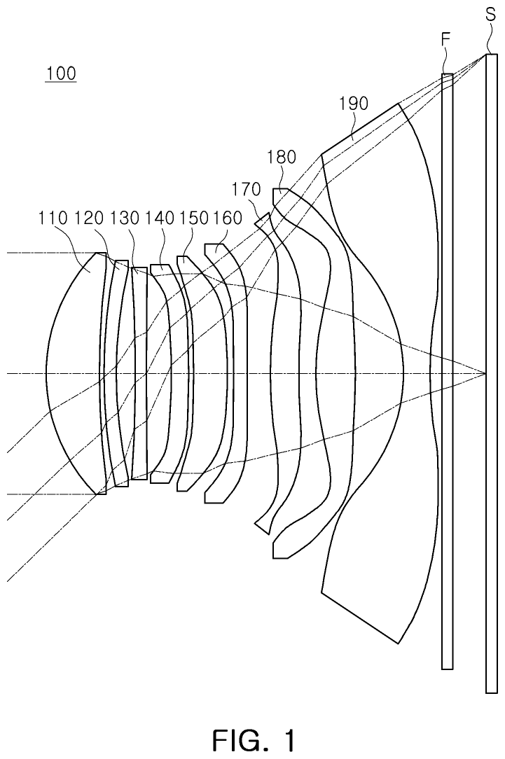

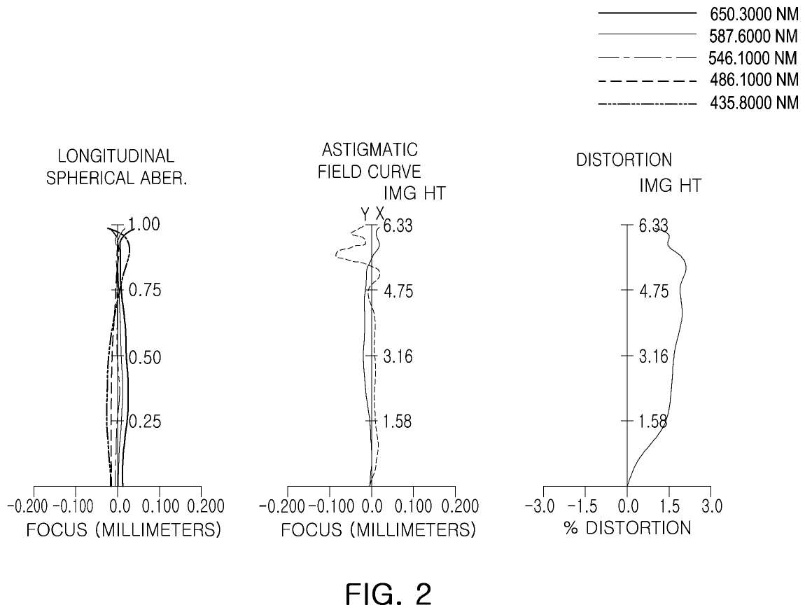

FIG. 1 is a configuration diagram illustrating an example optical imaging system according to a first embodiment. FIG. 2 is a graph indicating aberration properties of the example optical imaging system according to the first embodiment.

An optical imaging system 100 according to the first embodiment may include a first lens 110, a second lens 120, a third lens 130, a fourth lens 140, a fifth lens 150, a sixth lens 160, a seventh lens 170, an eighth lens 180, and a ninth lens 190.

The first lens 110 may have positive refractive power, an object-side surface may be convex, and an image-side surface may be concave. The first lens 110 may have a refractive index of 1.55 or lower, and an Abbe number may be 50 or more. The first lens 110 may be formed of a plastic material. Both surfaces of the first lens 110 may be aspherical.

The second lens 120 may have negative refractive power, an object-side surface may be convex, and an image-side surface may be concave. A refractive index of the second lens 120 may be 1.60 or more, preferably 1.65 or more, and an Abbe number may be less than 20. The second lens 120 may be formed of a plastic material. Both surfaces of the second lens 120 may be aspherical.

The third lens 130 may have positive refractive power, an object-side surface may be convex, and an image-side surface may be concave. A refractive index of the third lens 130 may be 1.60 or more, preferably 1.65 or more, and an Abbe number may be less than 20. The third lens 130 may be formed of a plastic material. Both surfaces of the third lens 130 may be aspherical.

The fourth lens 140 may have positive refractive power, an object-side surface may be concave, and an image-side surface may be convex. The fourth lens 140 may have a refractive index of 1.55 or more and less than 1.60, and an Abbe number may be 30 or more and less than 50. The fourth lens 140 may be formed of a plastic material. Both surfaces of the fourth lens 140 may be aspherical.

The fifth lens 150 may have positive refractive power, an object-side surface may be concave, and an image-side surface may be convex. The fifth lens 150 may have a refractive index of less than 1.6, and an Abbe number may be 50 or more. The fifth lens 150 may be formed of a plastic material. Both surfaces of the fifth lens 150 may be aspherical.

The sixth lens 160 may have negative refractive power, an object-side surface may be convex, and an image-side surface may be concave. A refractive index of the sixth lens 160 may be 1.60 or more, preferably 1.65 or more, and an Abbe number may be less than 20. The sixth lens 160 may be formed of a plastic material. Both surfaces of the sixth lens 160 may be aspherical.

The seventh lens 170 may have positive refractive power, an object-side surface may be convex, and an image-side surface may be concave. A refractive index of the seventh lens 170 may be 1.55 or more and less than 1.60, and an Abbe number may be 30 or more and less than 50. The seventh lens 170 may be formed of a plastic material. Both surfaces of the seventh lens 170 may be aspherical. The seventh lens 170 may include two or more inflection points on at least one of an object-side surface and an image-side surface, and preferably, on both surfaces.

The eighth lens 180 may have positive refractive power, and both an object-side surface and an image-side surface may be convex. The eighth lens 180 may have a refractive index of 1.55 or lower, and an Abbe number of 50 or more. The eighth lens 180 may be formed of a plastic material. Both surfaces of the eighth lens 180 may be aspherical. The eighth lens 180 may include two or more inflection points on an object-side surface or an image-side surface, and preferably, an object-side surface.

The ninth lens 190 may have negative refractive power, and both an object-side surface and an image-side surface may be concave. A refractive index of the ninth lens 190 may be 1.55 or lower, and an Abbe number of 50 or more. The ninth lens 190 may be formed of a plastic material. Both surfaces of the ninth lens 190 may be aspherical.

An image sensor S may be disposed on an image side of the ninth lens 190, and an infrared cut-off filter F may be disposed between the ninth lens 190 and the image sensor S.

According to the first embodiment, the second lens 120, the third lens 130, and the sixth lens 160 may be provided as high-index lenses having a refractive index of 1.60 or more. Accordingly, a sweep angle may be reduced, thereby reducing flare.

Table 1 and Table 2 below may list lens characteristics and aspheric values of the example optical imaging system 100 according to the first embodiment.

TABLE 1

| | Radius of | Thickness/ | Refractive | Abbe | Effective |
|---|---|---|---|---|---|
| Surface | Curvature | Distance | Index | number | radius |
| 1 | 3.5803 | 1.1158 | 1.546 | 55.99 | 2.414 |
| 2 | 21.4321 | 0.0829 | | | 2.338 |
| 3 | 8.5769 | 0.2500 | 1.689 | 18.15 | 2.271 |
| 4 | 5.3930 | 0.3728 | | | 2.142 |
| 5 | 21.5067 | 0.2501 | 1.689 | 18.15 | 2.109 |
| 6(stop) | 24.9633 | 0.4764 | | | 2.014 |
| 7 | −59.7181 | 0.3765 | 1.571 | 37.40 | 2.033 |
| 8 | −13.4432 | 0.0893 | | | 2.196 |
| 9 | −12.4481 | 0.6837 | 1.546 | 55.99 | 2.263 |
| 10 | −8.9727 | 0.1298 | | | 2.339 |
| 11 | 534.6378 | 0.2500 | 1.689 | 18.15 | 2.394 |
| 12 | 15.0624 | 0.5129 | | | 2.588 |
| 13 | 6.9149 | 0.5498 | 1.571 | 37.40 | 2.991 |
| 14 | 6.9876 | 0.3459 | | | 3.230 |
| 15 | 4.5879 | 0.8269 | 1.546 | 55.99 | 3.410 |
| 16 | −7.1721 | 0.9677 | | | 3.694 |
| 17 | −6.6181 | 0.5000 | 1.546 | 55.99 | 4.367 |
| 18 | 3.2704 | 0.2634 | | | 5.384 |
| 19 | Infinity | 0.2100 | 1.519 | 64.20 | 5.866 |
| 20 | Infinity | 0.6940 | | | 5.936 |
| 21 | Infinity | 0.0060 | | | 6.339 |

TABLE 2

| Surface | 1 | 2 | 3 | 4 | 5 | 6 | 7 | 8 | 9 |
|---|---|---|---|---|---|---|---|---|---|
| K | −3.21E−01 | 3.48E+01 | 8.40E+00 | −1.93E+00 | 7.28E+01 | 3.60E+01 | 0.00E+00 | 3.33E+01 | 2.77E+01 |
| A | 1.97E−03 | 1.17E−02 | 2.16E−03 | −6.17E−03 | −1.32E−02 | −9.63E−03 | 3.94E−03 | 4.78E−02 | 4.75E−02 |
| B | −1.35E−04 | −1.20E−02 | −1.70E−02 | −8.47E−03 | −4.03E−03 | −2.49E−03 | −1.13E−02 | −5.98E−02 | −6.61E−02 |
| C | 5.75E−04 | 7.35E−03 | 1.17E−02 | 5.15E−03 | 2.01E−03 | 1.88E−04 | 3.79E−03 | 4.23E−02 | 4.97E−02 |
| D | −4.61E−04 | −2.86E−03 | −4.80E−03 | −1.07E−03 | 1.12E−04 | 2.55E−03 | −4.28E−04 | −2.46E−02 | −2.92E−02 |
| E | 2.46E−04 | 7.16E−04 | 1.28E−03 | −2.89E−04 | −2.28E−04 | −2.29E−03 | −8.40E−04 | 1.00E−02 | 1.19E−02 |
| F | −8.89E−05 | −1.13E−04 | −2.17E−04 | 2.65E−04 | 6.46E−05 | 1.15E−03 | 5.91E−04 | −2.64E−03 | −3.03E−03 |
| G | 2.20E−05 | 1.02E−05 | 2.11E−05 | −7.72E−05 | −1.09E−05 | −3.75E−04 | −1.46E−04 | 4.30E−04 | 4.65E−04 |
| H | −3.55E−06 | −4.03E−07 | −8.92E−07 | 1.08E−05 | 1.30E−06 | 7.70E−05 | −1.86E−05 | −3.88E−05 | −3.91E−05 |
| J | 3.36E−07 | 0.00E+00 | 0.00E+00 | −6.07E−07 | −7.49E−08 | −8.96E−06 | 2.05E−05 | 1.48E−06 | 1.39E−06 |
| L | −1.42E−08 | 0.00E+00 | 0.00E+00 | 0.00E+00 | 0.00E+00 | 4.51E−07 | −5.09E−06 | 0.00E+00 | 0.00E+00 |
| M | 0.00E+00 | 0.00E+00 | 0.00E+00 | 0.00E+00 | 0.00E+00 | 0.00E+00 | 5.64E−07 | 0.00E+00 | 0.00E+00 |
| N | 0.00E+00 | 0.00E+00 | 0.00E+00 | 0.00E+00 | 0.00E+00 | 0.00E+00 | −2.41E−08 | 0.00E+00 | 0.00E+00 |
| O | 0.00E+00 | 0.00E+00 | 0.00E+00 | 0.00E+00 | 0.00E+00 | 0.00E+00 | 0.00E+00 | 0.00E+00 | 0.00E+00 |
| P | 0.00E+00 | 0.00E+00 | 0.00E+00 | 0.00E+00 | 0.00E+00 | 0.00E+00 | 0.00E+00 | 0.00E+00 | 0.00E+00 |
| Surface | 10 | 11 | 12 | 13 | 14 | 15 | 16 | 17 | 18 |
| K | 1.29E+01 | 0.00E+00 | 0.00E+00 | 0.00E+00 | 0.00E+00 | −1.91E+00 | 0.00E+00 | 0.00E+00 | −3.05E+00 |
| A | 6.22E−02 | 7.43E−02 | 3.17E−02 | −3.30E−03 | −1.06E−02 | 1.56E−02 | 3.48E−02 | −4.16E−02 | −4.36E−02 |
| B | −1.10E−01 | −1.31E−01 | −6.45E−02 | −1.41E−02 | −2.80E−02 | −2.48E−02 | −1.76E−02 | 4.74E−03 | 9.53E−03 |
| C | 9.05E−02 | 1.03E−01 | 4.96E−02 | 1.33E−02 | 2.85E−02 | 1.92E−02 | 1.20E−02 | −7.51E−04 | −1.04E−03 |
| D | −4.96E−02 | −5.28E−02 | −2.70E−02 | −6.99E−03 | −1.82E−02 | −1.12E−02 | −7.72E−03 | 1.28E−03 | −5.14E−05 |
| E | 1.63E−02 | 1.52E−02 | 1.11E−02 | 2.09E−03 | 8.25E−03 | 4.80E−03 | 3.72E−03 | −7.34E−04 | 4.20E−05 |
| F | −1.04E−03 | 8.89E−04 | −3.40E−03 | −1.74E−04 | −2.72E−03 | −1.51E−03 | −1.30E−03 | 2.18E−04 | −8.26E−06 |
| G | −1.87E−03 | −3.20E−03 | 7.59E−04 | −1.39E−04 | 6.57E−04 | 3.46E−04 | 3.27E−04 | −3.97E−05 | 9.79E−07 |
| H | 1.06E−03 | 1.65E−03 | −1.19E−04 | 7.17E−05 | −1.15E−04 | −5.66E−05 | −5.84E−05 | 4.81E−06 | −7.89E−08 |
| J | −3.08E−04 | −4.94E−04 | 1.26E−05 | −1.83E−05 | 1.43E−05 | 6.49E−06 | 7.39E−06 | −4.00E−07 | 4.47E−09 |
| L | 5.61E−05 | 9.75E−05 | −8.52E−07 | 2.93E−06 | −1.23E−06 | −5.10E−07 | −6.55E−07 | 2.31E−08 | −1.78E−10 |
| M | −6.43E−06 | −1.29E−05 | 3.22E−08 | −3.07E−07 | 6.89E−08 | 2.64E−08 | 3.96E−08 | −9.14E−10 | 4.88E−12 |
| N | 4.26E−07 | 1.11E−06 | −4.94E−10 | 2.04E−08 | −2.28E−09 | −8.37E−10 | −1.56E−09 | 2.36E−11 | −8.76E−14 |
| O | −1.25E−08 | −5.57E−08 | 0.00E+00 | −7.85E−10 | 3.43E−11 | 1.40E−11 | 3.59E−11 | −3.60E−13 | 9.24E−16 |
| P | 0.00E+00 | 1.24E−09 | 0.00E+00 | 1.33E−11 | −3.87E−14 | −8.35E−14 | −3.66E−13 | 2.45E−15 | −4.35E−18 |

### Second Embodiment

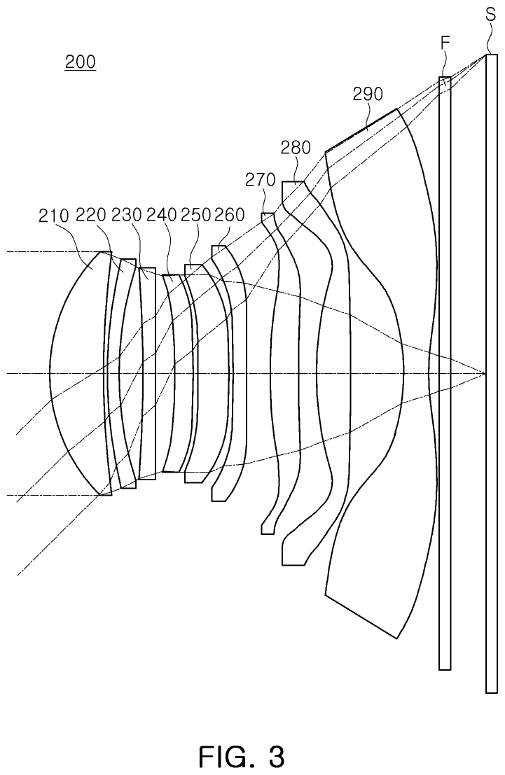

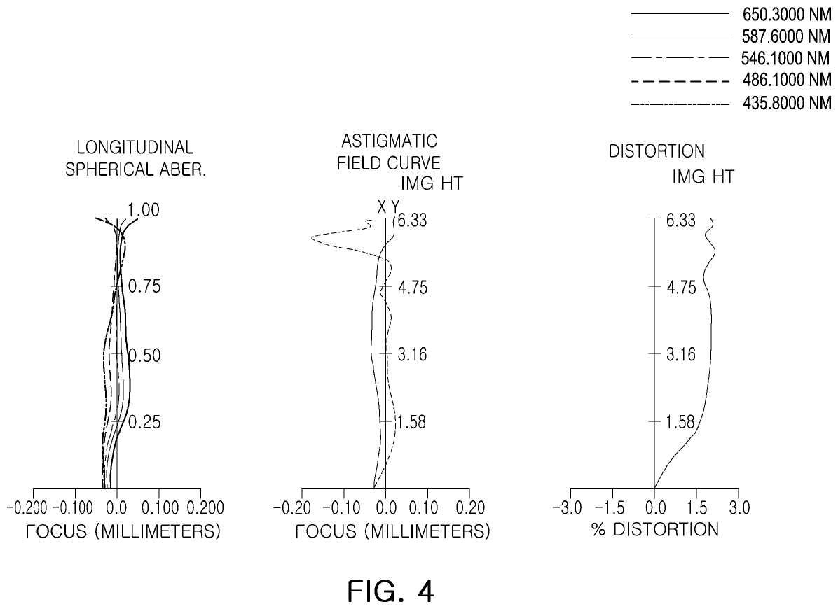

FIG. 3 is a configuration diagram illustrating an example optical imaging system according to a second embodiment. FIG. 4 is a graph indicating aberration properties of the example optical imaging system according to the second embodiment.

The optical imaging system 200 according to the second embodiment may include a first lens 210, a second lens 220, a third lens 230, a fourth lens 240, a fifth lens 250, a sixth lens 260, a seventh lens 270, an eighth lens 280, and a ninth lens 290.

The first lens 210 may have positive refractive power, an object-side surface may be convex, and an image-side surface may be concave. A refractive index of the first lens 210 may be 1.55 or lower, and an Abbe number may be 50 or more. The first lens 210 may be formed of a plastic material. Both surfaces of the first lens 210 may be aspherical.

The second lens 220 may have negative refractive power, an object-side surface may be convex, and an image-side surface may be concave. The second lens 220 may have a refractive index of 1.60 or more, preferably 1.65 or more, and an Abbe number may be less than 20. The second lens 220 may be formed of a plastic material. Both surfaces of the second lens 220 may be aspherical.

The third lens 230 may have negative refractive power, an object-side surface may be convex, and an image-side surface may be concave. The third lens 230 may have a refractive index of 1.60 or more, preferably 1.65 or more, and an Abbe number may be less than 20. The third lens 230 may be formed of a plastic material. Both surfaces of the third lens 230 may be aspherical.

The fourth lens 240 may have positive refractive power, an object-side surface may be concave, and an image-side surface may be convex. The fourth lens 240 may have a refractive index of 1.55 or more and less than 1.60, and an Abbe number may be 30 or more and less than 50. The fourth lens 240 may be formed of a plastic material. Both surfaces of the fourth lens 240 may be aspherical.

The fifth lens 250 may have positive refractive power, an object-side surface may be concave, and an image-side surface may be convex. The fifth lens 250 may have a refractive index of less than 1.6, and an Abbe number may be 50 or more. The fifth lens 250 may be formed of a plastic material. Both surfaces of the fifth lens 250 may be aspherical.

The sixth lens 260 may have negative refractive power, and both an object-side surface and an image-side surface may be concave. A refractive index of the sixth lens 260 may be 1.60 or more, preferably 1.65 or more, and an Abbe number may be less than 20. The sixth lens 260 may be formed of a plastic material. Both surfaces of the sixth lens 260 may be aspherical.

The seventh lens 270 may have positive refractive power, an object-side surface may be convex, and an image-side surface may be concave. A refractive index of the seventh lens 270 may be 1.55 or more and less than 1.60, and an Abbe number may be 30 or more and less than 50. The seventh lens 270 may be formed of a plastic material. Both surfaces of the seventh lens 270 may be aspherical. The seventh lens 270 may include two or more inflection points on at least one of an object-side surface and an image-side surface, and preferably, on both surfaces.

The eighth lens 280 may have positive refractive power, and both an object-side surface and an image-side surface may be convex. The eighth lens 280 may have a refractive index of 1.55 or lower, and an Abbe number of 50 or more. The eighth lens 280 may be formed of a plastic material. Both surfaces of the eighth lens 280 may be aspherical. The eighth lens 280 may include two or more inflection points on an object-side surface or an image-side surface, and preferably, on an object-side surface.

The ninth lens 290 may have negative refractive power, and both an object-side surface and an image-side surface may be concave. The ninth lens 290 may have a refractive index of 1.55 or lower, and an Abbe number of 50 or more. The ninth lens 290 may be formed of a plastic material. Both surfaces of the ninth lens 290 may be aspherical.

An image sensor S may be disposed on an image side of the ninth lens 290, and an infrared cut-off filter F may be disposed between the ninth lens 290 and the image sensor S.

According to the second embodiment, the second lens 220, the third lens 230, and the sixth lens 260 may be provided as high-index lenses having a refractive index of 1.60 or more. Accordingly, a sweep angle may be reduced, thereby reducing flare.

Table 3 and Table 4 below may list lens characteristics and aspheric values of example optical imaging system 200 according to the second embodiment.

TABLE 3

| | Radius of | Thickness/ | Refractive | Abbe | Effective |
|---|---|---|---|---|---|
| Surface | Curvature | Distance | Index | number | radius |
| 1 | 3.3991 | 1.1105 | 1.546 | 55.99 | 2.403 |
| 2 | 18.3690 | 0.0600 | | | 2.335 |
| 3 | 7.9364 | 0.2500 | 1.689 | 18.15 | 2.246 |
| 4 | 5.0857 | 0.4855 | | | 2.110 |
| 5 | 25.9797 | 0.2500 | 1.689 | 18.15 | 2.072 |
| 6(stop) | 21.6498 | 0.3891 | | | 1.966 |
| 7 | −219.8192 | 0.3840 | 1.571 | 37.40 | 1.921 |
| 8 | −13.2683 | 0.0844 | | | 1.944 |
| 9 | −12.6798 | 0.6459 | 1.546 | 55.99 | 1.933 |
| 10 | −9.6538 | 0.0703 | | | 2.140 |
| 11 | −110.8318 | 0.2709 | 1.689 | 18.15 | 2.276 |
| 12 | 17.0600 | 0.4996 | | | 2.498 |
| 13 | 6.2154 | 0.5590 | 1.571 | 37.40 | 3.005 |
| 14 | 7.1136 | 0.3592 | | | 3.170 |
| 15 | 4.4778 | 0.6989 | 1.537 | 55.74 | 3.395 |
| 16 | −10.2066 | 1.0764 | | | 3.788 |
| 17 | −7.8341 | 0.5000 | 1.537 | 55.74 | 4.405 |
| 18 | 3.3805 | 0.2390 | | | 5.241 |
| 19 | Infinity | 0.2100 | 1.519 | 64.20 | 5.794 |
| 20 | Infinity | 0.6730 | | | 5.873 |
| 21 | Infinity | 0.0270 | | | 6.332 |

TABLE 4

| Surface | 1 | 2 | 3 | 4 | 5 | 6 | 7 | 8 | 9 |
|---|---|---|---|---|---|---|---|---|---|
| K | −4.13E−01 | 2.95E+01 | 9.38E+00 | −3.74E−01 | 7.90E+01 | 5.46E+01 | 0.00E+00 | 3.30E+01 | 2.64E+01 |
| A | 1.64E−03 | 7.27E−03 | −3.99E−03 | −9.73E−03 | −2.18E−02 | −1.96E−02 | 2.25E−03 | 4.09E−02 | 4.32E−02 |
| B | 8.86E−04 | −4.04E−03 | −1.62E−03 | 1.55E−03 | 2.05E−03 | 3.96E−03 | −2.92E−02 | −6.54E−02 | −7.09E−02 |
| C | −6.26E−04 | 1.63E−03 | 7.06E−04 | −2.86−E04 | 1.27E−03 | −2.60E−03 | 6.35E−02 | 6.46E−02 | 6.59E−02 |
| D | 4.37E−04 | −5.77E−04 | −3.98E−04 | −1.03E−04 | −9.73E−04 | 4.30E−03 | −9.88E−02 | −4.62E−02 | −4.30E−02 |
| E | −2.05E−04 | 1.56E−04 | 1.70E−04 | 5.16E−05 | 5.09E−04 | −3.64E−03 | 1.03E−01 | 2.11E−02 | 1.78E−02 |
| F | 6.58E−05 | −2.82E−05 | −4.03E−05 | 1.46E−05 | −1.60E−04 | 1.89E−03 | −7.38E−02 | −6.08E−03 | −4.47E−03 |
| G | −1.38E−05 | 2.92E−06 | 4.97E−06 | −1.16E−05 | 2.67E−05 | −6.25E−04 | 3.71E−02 | 1.07E−03 | 6.72E−04 |
| H | 1.77E−06 | −1.34E−07 | −2.46E−07 | 2.45E−06 | −2.03E−06 | 1.27E−04 | −1.29E−02 | −1.05E−04 | −5.54E−05 |
| J | −1.22E−07 | 0.00E+00 | 0.00E+00 | −1.82E−07 | 4.37E−08 | −1.44E−05 | 3.08E−03 | 4.41E−06 | 1.94E−06 |
| L | 3.11E−09 | 0.00E+00 | 0.00E+00 | 0.00E+00 | 0.00E+00 | 7.10E−07 | −4.76E−04 | 0.00E+00 | 0.00E+00 |
| M | 0.00E+00 | 0.00E+00 | 0.00E+00 | 0.00E+00 | 0.00E+00 | 0.00E+00 | 4.30E−05 | 0.00E+00 | 0.00E+00 |
| N | 0.00E+00 | 0.00E+00 | 0.00E+00 | 0.00E+00 | 0.00E+00 | 0.00E+00 | −1.72E−06 | 0.00E+00 | 0.00E+00 |
| O | 0.00E+00 | 0.00E+00 | 0.00E+00 | 0.00E+00 | 0.00E+00 | 0.00E+00 | 0.00E+00 | 0.00E+00 | 0.00E+00 |
| P | 0.00E+00 | 0.00E+00 | 0.00E+00 | 0.00E+00 | 0.00E+00 | 0.00E+00 | 0.00E+00 | 0.00E+00 | 0.00E+00 |

| Surface | 10 | 11 | 12 | 13 | 14 | 15 | 16 | 17 | 18 |
|---|---|---|---|---|---|---|---|---|---|
| K | 1.38E+01 | 0.00E+00 | 0.00E+00 | 0.00E+00 | 0.00E+00 | −1.54E+00 | 0.00E+00 | 0.00E+00 | −5.01E+00 |
| A | 9.83E−02 | 8.81E−02 | 1.18E−02 | −9.72E−03 | −1.90E−02 | 4.86E−03 | 2.84E−02 | −5.32E−02 | −4.13E−02 |
| B | −1.74E−01 | −1.67E−01 | −3.63E−02 | −3.98E−03 | −1.49E−02 | −1.70E−02 | −1.76E−02 | 9.66E−03 | 1.03E−02 |
| C | 1.53E−01 | 1.53E−01 | 2.18E−02 | 7.39E−03 | 2.32E−02 | 1.63E−02 | 1.29E−02 | −7.19E−04 | −1.39E−03 |
| D | −8.43E−02 | −1.02E−01 | −5.40E−03 | −7.23E−03 | −1.93E−02 | −1.08E−02 | −7.05E−03 | 1.58E−04 | −3.08E−05 |
| E | 2.68E−02 | 5.70E−02 | −9.13E−04 | 4.56E−03 | 1.06E−02 | 5.12E−03 | 2.70E−03 | −1.07E−04 | 6.20E−05 |
| F | −1.96E−03 | −2.78E−02 | 1.16E−03 | −1.94E−03 | −4.01E−03 | −1.79E−03 | −7.42E−04 | 3.44E−05 | −1.51E−05 |
| G | −2.50E−03 | 1.13E−02 | −4.22E−04 | 5.74E−04 | 1.08E−03 | 4.63E−04 | 1.50E−04 | −6.19E−06 | 2.11E−06 |
| H | 1.40E−03 | −3.62E−03 | 8.90E−05 | −1.19E−04 | −2.09E−04 | −8.88E−05 | −2.24E−05 | 7.14E−07 | −1.95E−07 |
| J | −4.08E−04 | 8.58E−04 | −1.18E−05 | 1.73E−05 | 2.91E−05 | 1.25E−05 | 2.48E−06 | −5.61E−08 | 1.24E−08 |
| L | 7.50E−05 | −1.46E−04 | 9.69E−07 | −1.74E−06 | −2.88E−06 | −1.26E−06 | −2.00E−07 | 3.08E−09 | −5.44E−10 |
| M | −8.78E−06 | 1.72E−05 | −4.52E−08 | 1.16E−07 | 1.97E−07 | 8.81E−08 | 1.14E−08 | −1.17E−10 | 1.63E−11 |
| N | 5.97E−07 | −1.32E−06 | 9.21E−10 | −4.75E−09 | −8.83E−09 | 4.06E−09 | −4.27E−10 | 2.97E−12 | −3.16E−13 |
| O | −1.80E−08 | 5.98E−08 | 0.00E+00 | 1.04E−10 | 2.34E−10 | 1.11E−10 | 9.52E−12 | −4.50E−14 | 3.59E−15 |
| P | 0.00E+00 | −1.21E−09 | 0.00E+00 | −8.06E−13 | −2.76E−12 | −1.36E−12 | −9.48E−14 | 3.10E−16 | −1.81E−17 |

### Third Embodiment

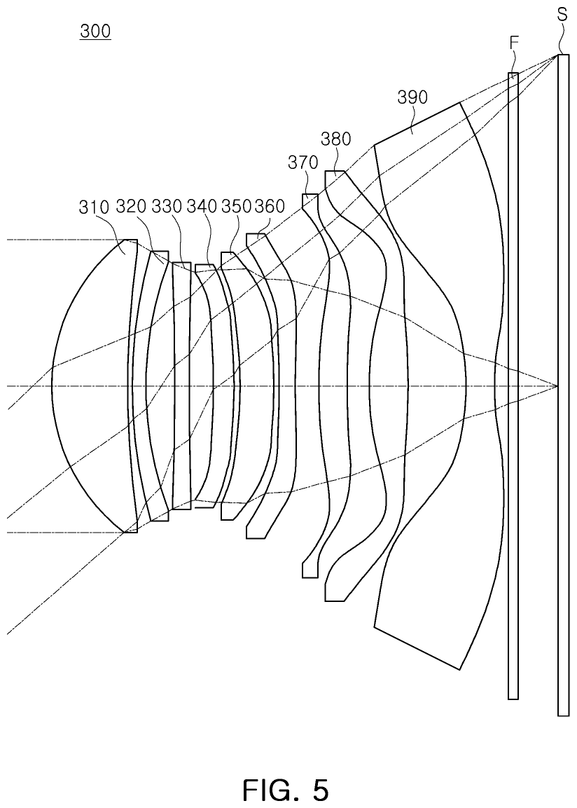

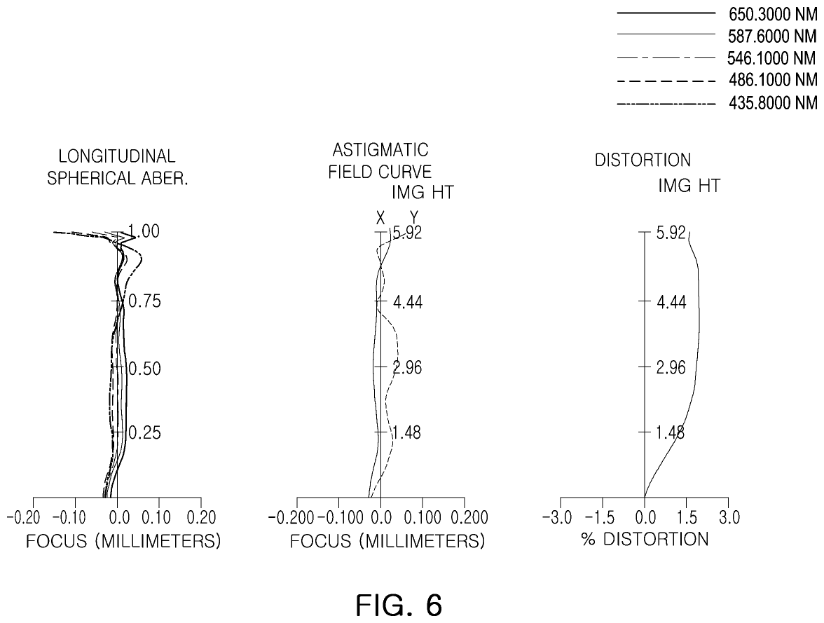

FIG. 5 is a configuration diagram illustrating an example optical imaging system according to a third embodiment. FIG. 6 is a graph indicating aberration properties of the example optical imaging system according to the third embodiment.

An optical imaging system 300 according to the third embodiment may include a first lens 310, a second lens 320, a third lens 330, a fourth lens 340, a fifth lens 350, a sixth lens 360, a seventh lens 370, an eighth lens 380, and a ninth lens 390.

The first lens 310 may have positive refractive power, an object-side surface may be convex, and an image-side surface may be concave. The first lens 310 may have a refractive index of 1.55 or lower, and an Abbe number may be 50 or more. The first lens 310 may be formed of a plastic material. Both surfaces of the first lens 310 may be aspherical.

The second lens 320 may have negative refractive power, an object-side surface may be convex, and an image-side surface may be concave. The second lens 320 may have a refractive index of 1.60 or more, preferably 1.65 or more, and an Abbe number may be less than 20. The second lens 320 may be formed of a plastic material. Both surfaces of the second lens 320 may be aspherical.

The third lens 330 may have negative refractive power, an object-side surface may be convex, and an image-side surface may be concave. The third lens 330 may have a refractive index of 1.60 or more, preferably 1.65 or more, and an Abbe number may be less than 20. The third lens 330 may be formed of a plastic material. Both surfaces of the third lens 330 may be aspherical.

The fourth lens 340 may have positive refractive power, an object-side surface may be concave, and an image-side surface may be convex. The fourth lens 340 may have a refractive index of 1.55 or more and less than 1.60, and an Abbe number may be 30 or more and less than 50. The fourth lens 340 may be formed of a plastic material. Both surfaces of the fourth lens 340 may be aspherical.

The fifth lens 350 may have positive refractive power, an object-side surface may be concave, and an image-side surface may be convex. The fifth lens 350 may have a refractive index of less than 1.6, and an Abbe number may be 50 or more. The fifth lens 350 may be formed of a plastic material. Both surfaces of the fifth lens 350 may be aspherical.

The sixth lens 360 may have negative refractive power, and both an object-side surface and an image-side surface may be concave. A refractive index of the sixth lens 360 may be 1.60 or more, preferably 1.65 or more, and an Abbe number may be less than 20. The sixth lens 360 may be formed of a plastic material. Both surfaces of the sixth lens 360 may be aspherical.

The seventh lens 370 may have positive refractive power, an object-side surface may be convex, and an image-side surface may be concave. A refractive index of the seventh lens 370 may be 1.55 or more and less than 1.60, and an Abbe number may be 30 or more and less than 50. The seventh lens 370 may be formed of a plastic material. Both surfaces of the seventh lens 370 may be aspherical. The seventh lens 370 may include two or more inflection points on at least one of an object-side surface and an image-side surface, preferably, on both surfaces.

The eighth lens 380 may have positive refractive power, and both an object-side surface and an image-side surface may be convex. The eighth lens 380 may have a refractive index of 1.55 or lower, and an Abbe number of 50 or more. The eighth lens 380 may be formed of a plastic material. Both surfaces of the eighth lens 380 may be aspherical. The eighth lens 380 may include two or more inflection points on an object-side surface or an image-side surface, and preferably, on an object-side surface.

The ninth lens 390 may have negative refractive power, and both an object-side surface and an image-side surface may be concave. The ninth lens 390 may have a refractive index of 1.55 or lower, and an Abbe number of 50 or more. The ninth lens 390 may be formed of a plastic material. Both surfaces of the ninth lens 390 may be aspherical.

An image sensor S may be disposed on an image side of the ninth lens 390, and an infrared cut-off filter F may be disposed between the ninth lens 390 and the image sensor S.

According to the third embodiment, the second lens 320, the third lens 330, and the sixth lens 360 may be provided as high-index lenses having a refractive index of 1.60 or more. Accordingly, a sweep angle may be reduced, thereby reducing flare.

Table 5 and Table 6 below may list lens characteristics and aspheric values of the optical imaging system 300 according to the third embodiment.

TABLE 5

| | Radius of | Thickness/ | Refractive | Abbe | Effective |
|---|---|---|---|---|---|
| Surface | Curvature | Distance | Index | number | radius |
| 1 | 3.4187 | 1.3267 | 1.546 | 55.99 | 2.600 |
| 2 | 20.8479 | 0.0735 | | | 2.541 |
| 3 | 8.4879 | 0.2500 | 1.689 | 18.15 | 2.415 |
| 4 | 5.1295 | 0.4923 | | | 2.241 |
| 5 | 24.9119 | 0.2500 | 1.689 | 18.15 | 2.193 |
| 6(stop) | 24.2093 | 0.4310 | | | 2.048 |
| 7 | −93.3120 | 0.3721 | 1.571 | 37.40 | 2.024 |
| 8 | −13.3356 | 0.0865 | | | 2.172 |
| 9 | −12.6197 | 0.6357 | 1.546 | 55.99 | 2.298 |
| 10 | −9.8271 | 0.0782 | | | 2.396 |
| 11 | −69.0458 | 0.2851 | 1.689 | 18.15 | 2.531 |
| 12 | 16.7251 | 0.4136 | | | 2.705 |
| 13 | 5.8561 | 0.5261 | 1.571 | 37.40 | 3.207 |
| 14 | 7.1381 | 0.3703 | | | 3.408 |
| 15 | 4.5865 | 0.7002 | 1.537 | 55.74 | 3.545 |
| 16 | −9.5775 | 1.0360 | | | 3.837 |
| 17 | −7.6909 | 0.5000 | 1.537 | 55.74 | 4.309 |
| 18 | 3.3082 | 0.2293 | | | 5.093 |
| 19 | Infinity | 0.2100 | 1.519 | 64.20 | 5.507 |
| 20 | Infinity | 0.6730 | | | 5.570 |
| 21 | Infinity | 0.0270 | | | 5.926 |

TABLE 6

| Surface | 1 | 2 | 3 | 4 | 5 | 6 | 7 | 8 | 9 |
|---|---|---|---|---|---|---|---|---|---|
| K | −3.45E−01 | 2.35E+01 | 9.05E+00 | −2.94E−01 | 9.76E+01 | 9.37E+01 | 0.00E+00 | 3.38E+01 | 2.61E+01 |
| A | 5.78E−04 | 4.43E−03 | −3.76E−03 | −5.57E−03 | −1.11E−02 | −1.09E−02 | −3.72E−03 | 3.46E−02 | 3.41E−02 |
| B | 2.75E−03 | −3.90E−03 | −6.62E−03 | −5.66E−03 | −3.12E−03 | 4.72E−03 | 1.24E−02 | −4.49E−02 | −4.66E−02 |
| C | −3.25E−03 | 2.08E−03 | 4.58E−03 | 5.91E−03 | 9.89E−04 | −1.33E−02 | 4.63E−02 | 3.70E−02 | 3.62E−02 |
| D | 2.42E−03 | −6.49E−04 | −1.72E−03 | −3.93E−03 | 3.82E−04 | 1.67E−02 | 7.30E−02 | −2.44E−02 | −2.10E−02 |
| E | −1.10E−03 | 1.18E−04 | 3.95E−04 | 1.82E−03 | −3.42E−04 | −1.22E−02 | −7.40E−02 | 1.05E−02 | 7.51E−03 |
| F | 3.22E−04 | −1.24E−05 | −5.36E−05 | −5.60E−04 | 1.52E−04 | 5.82E−03 | 5.05E−02 | −2.87E−03 | −1.54E−03 |
| G | −5.97E−05 | 6.91E−07 | 4.02E−06 | 1.08E−04 | −3.96E−05 | −1.80E−03 | −2.37E−02 | 4.89E−04 | 1.72E−04 |
| H | 6.83E−06 | −1.71E−08 | −1.28E−07 | −1.16E−05 | 5.29E−06 | 3.48E−04 | 7.68E−03 | −4.78E−05 | −9.10E−06 |
| J | −4.36E−07 | 0.00E+00 | 0.00E+00 | 5.19E−07 | −2.77E−07 | −3.83E−05 | −1.68E−03 | 2.05E−06 | 1.40E−07 |
| L | 1.18E−08 | 0.00E+00 | 0.00E+00 | 0.00E+00 | 0.00E+00 | 1.83E−06 | 2.39E−04 | 0.00E+00 | 0.00E+00 |
| M | 0.00E+00 | 0.00E+00 | 0.00E+00 | 0.00E+00 | 0.00E+00 | 0.00E+00 | −1.98E−05 | 0.00E+00 | 0.00E+00 |
| N | 0.00E+00 | 0.00E+00 | 0.00E+00 | 0.00E+00 | 0.00E+00 | 0.00E+00 | 7.30E−07 | 0.00E+00 | 0.00E+00 |
| O | 0.00E+00 | 0.00E+00 | 0.00E+00 | 0.00E+00 | 0.00E+00 | 0.00E+00 | 0.00E+00 | 0.00E+00 | 0.00E+00 |
| P | 0.00E+00 | 0.00E+00 | 0.00E+00 | 0.00E+00 | 0.00E+00 | 0.00E+00 | 0.00E+00 | 0.00E+00 | 0.00E+00 |
| Surface | 10 | 11 | 12 | 13 | 14 | 15 | 16 | 17 | 18 |
| K | 1.41E+01 | 0.00E+00 | 0.00E+00 | 0.00E+00 | 0.00E+00 | −1.49E+00 | 0.00E+00 | 0.00E+00 | −6.33E+00 |
| A | 8.20E−02 | 7.85E−02 | 2.04E−02 | 4.72E−04 | −1.11E−02 | 4.18E−03 | 2.16E−02 | −6.43E−02 | −4.56E−02 |
| B | −1.37E−01 | −1.38E−01 | −5.63E−02 | −1.76E−02 | −2.11E−02 | −1.30E−02 | −8.50E−03 | 2.21E−02 | 1.61E−02 |
| C | 1.19E−01 | 1.11E−01 | 4.75E−02 | 1.47E−02 | 2.33E−02 | 8.99E−03 | 4.41E−03 | −1.00E−02 | −4.71E−03 |
| D | −6.69E−02 | −5.31E−02 | −2.60E−02 | −8.22E−03 | −1.69E−02 | −4.57E−03 | −2.38E−03 | 4.99E−03 | 1.16E−03 |
| E | 2.21E−02 | 1.08E−02 | 1.01E−02 | 3.37E−03 | 8.85E−03 | 1.67E−03 | 1.02E−03 | −1.81E−03 | −2.22E−04 |
| F | −2.20E−03 | 3.72E−03 | −2.93E−03 | −1.01E−03 | −3.33E−03 | −4.24E−04 | −3.10E−04 | 4.40E−04 | 3.15E−05 |
| G | −1.66E−03 | −3.98E−03 | 6.51E−04 | 2.14E−04 | 9.04E−04 | 7.38E−05 | 6.55E−05 | −7.30E−05 | −3.26E−06 |
| H | 9.81E−04 | 1.72E−03 | −1.11E−04 | −3.02E−05 | −1.78E−04 | −8.59E−06 | −9.80E−06 | 8.43E−06 | 2.44E−07 |
| J | −2.82E−04 | −4.79E−04 | 1.39E−05 | 2.42E−06 | 2.53E−05 | 6.23E−07 | 1.06E−06 | −6.85E−07 | −1.31E−08 |
| L | 5.06E−05 | 9.24E−05 | −1.20E−06 | −2.01E−08 | 2.56E−06 | −2.04E−08 | −8.21E−08 | 3.91E−08 | 5.03E−10 |
| M | −5.72E−06 | −1.23E−05 | 6.35E−08 | −1.79E−08 | 1.79E−07 | −6.78E−10 | 4.50E−09 | −1.54E−09 | −1.34E−11 |
| N | 3.75E−07 | 1.09E−06 | −1.52E−09 | 1.92E−09 | −8.25E−09 | 9.90E−11 | −1.65E−10 | 3.97E−11 | 2.33E−13 |
| O | −1.09E−08 | −5.69E−08 | 0.00E+00 | −8.91E−11 | 2.24E−10 | −3.92E−12 | 3.62E−12 | −6.06E−13 | −2.41E−15 |
| P | 0.00E+00 | 1.34E−09 | 0.00E+00 | 1.63E−12 | −2.71E−12 | 5.68E−14 | −3.56E−14 | 4.15E−15 | 1.12E−17 |

### Fourth Embodiment

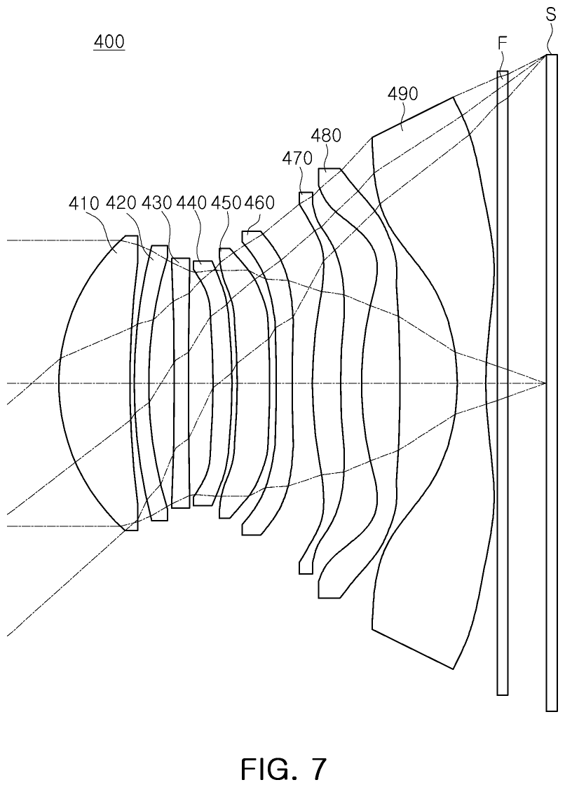

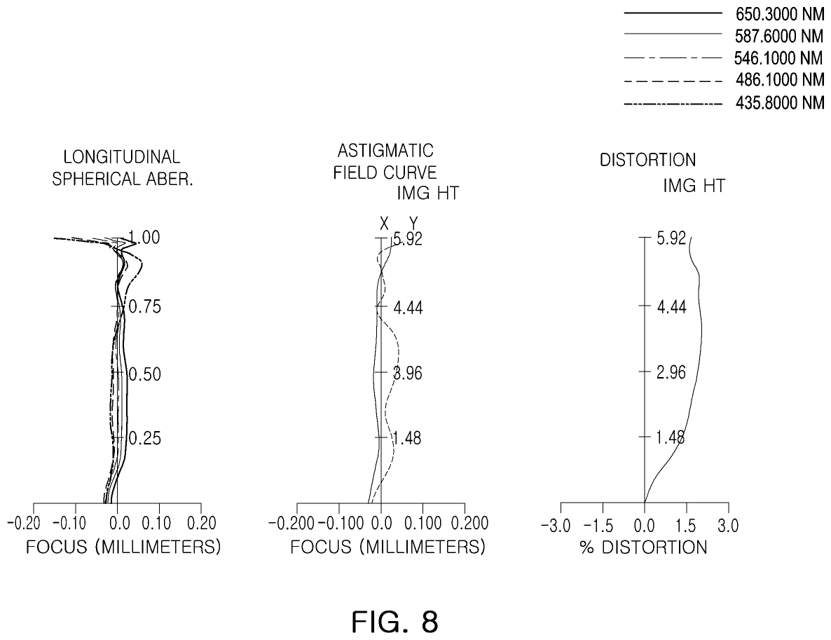

FIG. 7 is a configuration diagram illustrating an example optical imaging system according to a fourth embodiment. FIG. 8 is a graph indicating aberration properties of the example optical imaging system according to the fourth embodiment.

An optical imaging system 400 according to the fourth embodiment may include a first lens 410, a second lens 420, a third lens 430, a fourth lens 440, a fifth lens 450, a sixth lens 460, a seventh lens 470, an eighth lens 480, and a ninth lens 490.

The first lens 410 may have positive refractive power, an object-side surface may be convex, and an image-side surface may be concave. The first lens 410 may have a refractive index of 1.55 or lower, and an Abbe number may be 50 or more. The first lens 410 may be formed of a plastic material. Both surfaces of the first lens 410 may be aspherical.

The second lens 420 may have negative refractive power, an object-side surface may be convex, and an image-side surface may be concave. The second lens 420 may have a refractive index of 1.60 or more, preferably 1.65 or more, and an Abbe number may be less than 20. The second lens 420 may be formed of a plastic material. Both surfaces of the second lens 420 may be aspherical.

The third lens 430 may have negative refractive power, an object-side surface may be convex, and an image-side surface may be concave. The third lens 430 may have a refractive index of 1.60 or more, preferably 1.65 or more, and an Abbe number may be less than 20. The third lens 430 may be formed of a plastic material. Both surfaces of the third lens 430 may be aspherical.

The fourth lens 440 may have positive refractive power, an object-side surface may be concave, and an image-side surface may be convex. The fourth lens 440 may have a refractive index of 1.55 or more and less than 1.60, and an Abbe number may be 30 or more and less than 50. The fourth lens 440 may be formed of a plastic material. Both surfaces of the fourth lens 440 may be aspherical.

The fifth lens 450 may have positive refractive power, an object-side surface may be concave, and an image-side surface may be convex. The fifth lens 450 may have a refractive index of less than 1.6, and an Abbe number may be 50 or more. The fifth lens 450 may be formed of a plastic material. Both surfaces of the fifth lens 450 may be aspherical.

The sixth lens 460 may have negative refractive power, and both an object-side surface and an image-side surface may be concave. A refractive index of the sixth lens 460 may be 1.60 or more, and preferably 1.65 or more, and an Abbe number may be less than 20. The sixth lens 460 may be formed of a plastic material. Both surfaces of the sixth lens 460 may be aspherical.

The seventh lens 470 may have positive refractive power, an object-side surface may be convex, and an image-side surface may be concave. A refractive index of the seventh lens 470 may be 1.55 or more and less than 1.60, and an Abbe number may be 30 or more and less than 50. The seventh lens 470 may be formed of a plastic material. Both surfaces of the seventh lens 470 may be aspherical. The seventh lens 470 may include two or more inflection points on at least one of an object-side surface and an image-side surface, preferably, on both surfaces.

The eighth lens 480 may have positive refractive power, and both an object-side surface and an image-side surface may be convex. The eighth lens 480 may have a refractive index of 1.55 or more and less than 1.60, and an Abbe number of 30 or more and less than 50. The eighth lens 480 may be formed of a plastic material. Both surfaces of the eighth lens 480 may be aspherical. The eighth lens 480 may include two or more inflection points on an object-side surface or an image-side surface, and preferably, an object-side surface.

The ninth lens 490 may have negative refractive power, and both an object-side surface and an image-side surface may be concave. A refractive index of the ninth lens 490 may be 1.55 or lower, and an Abbe number may be 50 or more. The ninth lens 490 may be formed of a plastic material. Both surfaces of the ninth lens 490 may be aspherical.

An image sensor S may be disposed on an image side of the ninth lens 490, and an infrared cut-off filter F may be disposed between the ninth lens 490 and the image sensor S.

According to the fourth embodiment, the second lens 420, the third lens 430 and the sixth lens 460 may be provided as high-index lenses having a refractive index of 1.60 or more. Accordingly, a sweep angle may be reduced, thereby reducing flare.

Tables 7 and 8 below may list lens characteristics and aspheric values of the optical imaging system 400 according to the fourth embodiment.

TABLE 7

| | Radius of | Thickness/ | Refractive | Abbe | Effective |
|---|---|---|---|---|---|
| Surface | Curvature | Distance | Index | number | radius |
| 1 | 3.4372 | 1.3386 | 1.546 | 55.99 | 2.615 |
| 2 | 21.1327 | 0.0607 | | | 2.559 |
| 3 | 8.5480 | 0.2501 | 1.689 | 18.15 | 2.437 |
| 4 | 5.1749 | 0.4811 | | | 2.270 |
| 5 | 24.7815 | 0.2500 | 1.689 | 18.15 | 2.213 |
| 6(stop) | 24.1372 | 0.4309 | | | 2.047 |
| 7 | −94.2716 | 0.3685 | 1.571 | 37.40 | 2.022 |
| 8 | −13.3558 | 0.0869 | | | 2.170 |
| 9 | −12.6275 | 0.6372 | 1.546 | 55.99 | 2.287 |
| 10 | −9.8334 | 0.0723 | | | 2.399 |
| 11 | −59.9605 | 0.2872 | 1.689 | 18.15 | 2.528 |
| 12 | 17.4509 | 0.4096 | | | 2.699 |
| 13 | 5.9013 | 0.5254 | 1.571 | 37.40 | 3.207 |
| 14 | 7.1920 | 0.3669 | | | 3.396 |
| 15 | 4.6971 | 0.6884 | 1.571 | 37.40 | 3.512 |
| 16 | −11.1500 | 1.0610 | | | 3.846 |
| 17 | −7.8311 | 0.5001 | 1.537 | 55.74 | 4.399 |
| 18 | 3.3844 | 0.2187 | | | 5.108 |
| 19 | Infinity | 0.2100 | 1.519 | 64.20 | 5.503 |
| 20 | Infinity | 0.6730 | | | 5.568 |
| 21 | Infinity | 0.0270 | | | 5.927 |

TABLE 8

| Surface | 1 | 2 | 3 | 4 | 5 | 6 | 7 | 8 | 9 |
|---|---|---|---|---|---|---|---|---|---|
| K | −3.48E−01 | 2.36E+01 | 9.04E+00 | −3.85E−01 | 9.81E+01 | 9.33E+01 | 0.00E+00 | 3.38E+01 | 2.61E+01 |
| A | 3.13E−04 | 4.54E−03 | −3.08E−03 | −4.59E−03 | −1.09E−02 | −1.10E−02 | −1.97E−03 | 3.36E−02 | 3.15E−02 |
| B | 3.29E−03 | −4.04E−03 | −7.98E−03 | −8.62E−03 | −2.68E−03 | 5.88E−03 | 6.78E−03 | −4.00E−02 | −3.94E−02 |
| C | −3.97E−03 | 2.14E−03 | 5.99E−03 | 1.03E−02 | −3.36E−05 | −1.59E−02 | −3.21E−02 | 2.94E−02 | 2.75E−02 |
| D | 2.99E−03 | −6.44E−04 | −2.52E−03 | −7.50E−03 | 1.37E−03 | 1.96E−02 | 4.76E−02 | −1.84E−02 | −1.50E−02 |
| E | −1.39E−03 | 1.08E−04 | 6.58E−04 | 3.52E−03 | −8.850E−04 | −1.41E−02 | −4.40E−02 | 7.68E−03 | 4.96E−03 |
| F | 4.11E−04 | −9.78E−06 | −1.04E−04 | −1.04E−03 | 3.30E−04 | 6.55E−03 | 2.69E−02 | −2.02E−03 | −8.61E−04 |
| G | −7.81E−05 | 3.77E−07 | 9.18E−06 | 1.89E−04 | −7.50E−05 | −1.98E−03 | −1.11E−02 | 3.34E−04 | 6.15E−05 |
| H | 9.18E−06 | −2.65E−09 | −3.47E−07 | −1.89E−05 | 9.19E−06 | 3.74E−04 | 3.06E−03 | −3.21E−05 | 9.39E−07 |
| J | −6.06E−07 | 0.00E+00 | 0.00E+00 | 7.89E−07 | −4.63E−07 | −4.02E−05 | −5.57E−04 | 1.37E−06 | −2.47E−07 |
| L | 1.71E−08 | 0.00E+00 | 0.00E+00 | 0.00E+00 | 0.00E+00 | 1.89E−06 | 6.29E−05 | 0.00E+00 | 0.00E+00 |
| M | 0.00E+00 | 0.00E+00 | 0.00E+00 | 0.00E+00 | 0.00E+00 | 0.00E+00 | −3.89E−06 | 0.00E+00 | 0.00E+00 |
| N | 0.00E+00 | 0.00E+00 | 0.00E+00 | 0.00E+00 | 0.00E+00 | 0.00E+00 | 9.57E−08 | 0.00E+00 | 0.00E+00 |
| O | 0.00E+00 | 0.00E+00 | 0.00E+00 | 0.00E+00 | 0.00E+00 | 0.00E+00 | 0.00E+00 | 0.00E+00 | 0.00E+00 |
| P | 0.00E+00 | 0.00E+00 | 0.00E+00 | 0.00E+00 | 0.00E+00 | 0.00E+00 | 0.00E+00 | 0.00E+00 | 0.00E+00 |

| Surface | 10 | 11 | 12 | 13 | 14 | 15 | 16 | 17 | 18 |
|---|---|---|---|---|---|---|---|---|---|
| K | 1.41E+01 | 0.00E+00 | 0.00E+00 | 0.00E+00 | 0.00E+00 | −1.47E+00 | 0.00E+00 | 0.00E+00 | −6.40E+00 |
| A | 8.12E−02 | 7.84E−02 | 1.96E−02 | −1.27E−03 | −1.29E−02 | 3.41E−03 | 2.12E−02 | −6.31E−02 | −4.65E−02 |
| B | −1.36E−01 | −1.39E−01 | −5.37E−02 | −1.26E−02 | −1.83E−02 | −1.22E−02 | −1.04E−02 | 1.76E−02 | 1.60E−02 |
| C | 1.17E−01 | 1.14E−01 | 4.33E−02 | 8.43E−03 | 2.05E−02 | 8.42E−03 | 6.40E−03 | −5.72E−03 | −4.36E−03 |
| D | −6.54E−02 | −5.89E−02 | −2.23E−02 | −3.48E−03 | −1.52E−02 | −4.21E−03 | −3.35E−03 | 2.86E−03 | 9.92E−04 |
| E | 2.14E−02 | 1.73E−02 | 8.10E−03 | 9.81E−04 | 8.09E−03 | 1.51E−03 | 1.31E−03 | −1.15E−03 | −1.80E−04 |
| F | −1.95E−03 | −9.14E−04 | −2.24E−03 | −1.59E−04 | −3.08E−03 | −3.86E−04 | −3.74E−04 | 3.05E−04 | 2.48E−05 |
| G | −1.71E−03 | −1.79E−03 | 4.92E−04 | −6.81E−06 | 8.47E−04 | 6.86E−05 | 7.61E−05 | −5.34E−05 | −2.50E−06 |
| H | 9.87E−04 | 1.01E−03 | −8.63E−05 | 1.20E−05 | −1.68E−04 | −8.37E−06 | −1.11E−05 | 6.39E−06 | 1.83E−07 |
| J | −2.82E−04 | −3.18E−04 | 1.15E−05 | −3.51E−06 | 2.41E−05 | 6.70E−07 | 1.18E−06 | −5.32E−07 | −9.66E−09 |
| L | 5.05E−05 | 6.69E−05 | −1.05E−06 | 5.84E−07 | −2.46E−06 | −3.01E−08 | −9.10E−08 | 3.09E−08 | 3.62E−10 |
| M | −5.71E−06 | −9.59E−06 | 5.85E−08 | −6.13E−08 | 1.74E−07 | 1.84E−10 | 4.93E−09 | −1.23E−09 | −9.38E−12 |
| N | 3.74E−07 | 8.96E−07 | −1.46E−09 | 4.01E−09 | −8.11E−09 | 5.58E−11 | −1.78E−10 | 3.21E−11 | 1.59E−13 |
| O | −1.09E−08 | −4.92E−08 | 0.00E+00 | −1.49E−10 | 2.23E−10 | −2.73E−12 | 3.86E−12 | −4.94E−13 | −1.59E−15 |
| P | 0.00E+00 | 1.20E−09 | 0.00E+00 | 2.41E−12 | −2.73E−12 | 4.26E−14 | −3.76E−14 | 3.40E−15 | 7.08E−18 |

Table 9 below may list optical and physical parameters of the optical imaging system according to the first to fourth embodiments.

TABLE 9

| | First | Second | Third | Fourth |
|---|---|---|---|---|
| | embodiment | embodiment | embodiment | embodiment |
| f | 6.6073 | 6.5641 | 6.6868 | 6.6134 |
| f1 | 7.6977 | 7.4393 | 7.2890 | 7.3179 |
| f2 | −21.7784 | −21.3072 | −19.4014 | −19.6236 |
| f3 | 218.9187 | −193.0388 | −1456.9921 | −1600.4698 |
| f4 | 30.3069 | 24.7243 | 27.2156 | 27.2182 |
| f5 | 55.0025 | 68.8522 | 75.2340 | 75.2795 |
| f6 | −22.4946 | −21.4344 | −19.5103 | −19.5843 |
| f7 | 310.7942 | 70.3422 | 49.7154 | 50.1928 |
| f8 | 5.2520 | 5.8923 | 5.8753 | 5.8833 |
| f9 | −3.9360 | −4.3290 | −4.2391 | −4.3320 |
| TTL | 8.9538 | 8.8426 | 8.9660 | 8.9430 |
| BFL | 1.173 | 1.149 | 1.139 | 1.129 |
| F-number | 1.3735 | 1.3658 | 1.2868 | 1.2781 |
| FOV | 86.92 | 86.63 | 81.93 | 80.42 |
| IMG HT | 6.329 | 6.329 | 5.920 | 5.920 |
| T1 | 1.1158 | 1.1105 | 1.3267 | 1.3386 |
| T9 | 0.5000 | 0.5000 | 0.5000 | 0.5001 |
| ΣCT | 4.8028 | 4.6691 | 4.8459 | 4.8455 |
| ΣAT | 2.9777 | 3.0245 | 2.9814 | 2.9693 |

According to the aforementioned embodiments, the optical imaging system may obtain high-quality and bright images and may be manufactured to have a slim size, such that the optical imaging system may be employed in a mobile device having a limited space.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An optical imaging system, comprising:
a first lens, a second lens, a third lens, a fourth lens having positive refractive power, a fifth lens, a sixth lens, a seventh lens having positive refractive power, an eighth lens, and a ninth lens,
wherein the first lens to the ninth lens are disposed in order from an object side, and
wherein conditional expressions 1.0<F-number<1.4 and 1.30≤TTL/f<1.40 are satisfied,
where TTL is a distance from an object-side surface of the first lens to an image plane on an optical axis, and f is a focal length of the optical imaging system.

2. The optical imaging system of claim 1, wherein both an image-side surface of the third lens and an object-side surface of the fourth lens are concave.

3. The optical imaging system of claim 1, wherein the fifth lens has a concave object-side surface.

4. The optical imaging system of claim 1, wherein the sixth lens has a concave image-side surface.

5. The optical imaging system of claim 1, wherein the seventh lens and the eighth lens include an inflection point on at least one of an object-side surface and an image-side surface.

6. The optical imaging system of claim 1, wherein the eighth lens has a convex image-side surface.

7. The optical imaging system of claim 1, wherein the first lens to the ninth lens comprise three or more lenses which have a refractive index equal to or greater than 1.60.

8. The optical imaging system of claim 1, wherein a conditional expression 0.70≤TTL/(2*IMG HT)<0.80, is satisfied,
where IMG HT is a half of diagonal length of the image plane.

9. An optical imaging system, comprising:
a first lens, a second lens, a third lens, a fourth lens, a fifth lens, a sixth lens, a seventh lens, an eighth lens, and a ninth lens disposed in order from an object side,
wherein the seventh lens has positive refractive power, and
wherein the eighth lens has a convex image-side surface.

10. The optical imaging system of claim 9, wherein the second lens, the third lens and the sixth lens have a refractive index equal to or greater than 1.60.

11. The optical imaging system of claim 9, wherein the seventh lens and the eighth lens comprise an inflection point on at least one of an object-side surface and an image-side surface.

12. The optical imaging system of claim 9, wherein the fourth lens and the fifth lens have positive refractive power.

13. The optical imaging system of claim 9, wherein a conditional expression 1.0<F-number<1.4 is satisfied.

14. The optical imaging system of claim 9, wherein the sixth lens has negative refractive power and a concave image-side surface.

15. The optical imaging system of claim 9, wherein the third lens has positive refractive power.

16. The optical imaging system of claim 9, wherein the sixth lens has a convex object-side surface.

17. The optical imaging system of claim 9, wherein a conditional expression 1.30≤TTL/f<1.40 is satisfied,
where TTL is a distance from an object-side surface of the first lens to an image plane on the optical axis, and f is a focal length of the optical imaging system.

18. The optical imaging system of claim 9, wherein a conditional expression 0.70≤TTL/(2*IMG HT)<0.80 is satisfied,
where TTL is a distance from an object-side surface of the first lens to an image plane on an optical axis, and 2*IMG HT is a diagonal length of the image plane.
